(19) United States
(12) Patent Application Publication
(10) Pub. No.: US 2014/0358600 A1
(43) Pub. Date: Dec. 4, 2014

(54) ITEM PLACEMENT OPTIMIZER

(71) Applicant: Oracle International Corporation, Redwood Shores, CA (US)

(72) Inventor: David VENGEROV, San Jose, CA (US)

(73) Assignee: Oracle International Corporation, Redwood Shores, CA (US)

(21) Appl. No.: 13/905,256

(22) Filed: May 30, 2013

(51) Int. Cl. G06Q 10/06

(52) U.S. Cl. CPC G06Q 10/063
USPC 705/7.11

(57) ABSTRACT

A system is provided that that generates an optimal item placement for one or more items. The system receives one or more items, where each item includes an item height and an item width. The system further receives a container, where the container comprises a container height and a container width. The system further generates a number of copies for each item and a position within the container for each copy of each item, where each copy of each item is placed at the corresponding position within the container. The system further outputs the number of copies for each item and the position within the container for each copy of each item.

### FIELD

One embodiment is directed to a computer system, and more particularly, to a computer system that optimizes item placement.

### BACKGROUND

A two-dimensional rectangular packing problem is an optimization problem of allocating a set of rectangular items to a larger container (such as a rectangular box or rectangular board) with an objective of minimizing wasted space of the larger container, or maximizing a total value of all rectangular items placed in the larger container. The two-dimensional rectangular packing problem has numerous applications in the cutting and packing industry (e.g., wood, glass, and cloth industries, newspapers paging, very-large scale integration (“VLSI”) circuit design, floor planning for a data center that includes one or more servers, etc.). Other examples of the two-dimensional rectangular packing problem can include packing items at a supermarket into a freezer chest or a pegboard, hanging batteries at a checkout stand of a supermarket, packing modules into a VLSI circuit board, packing servers and other equipment into a limited floor space of a data center, or packing items in a shipping container.

The two-dimensional rectangular packing problem is a “non-deterministic polynomial-time (“NP”)-hard problem” (i.e., a problem that cannot be solved optimally in a time that is a polynomial function of the number of items). The complexity of the problem can be increased where multiple copies of each item can be placed, and a total revenue is an increasing function of the number of copies of each item. Thus, a two-dimensional rectangular packing problem, in general, is the problem of finding an optimal placement of items in a two-dimensional space to maximize revenue, by deciding where to place an item and how many copies of an item to allocate subject to business and operation constraints.

### SUMMARY

One embodiment is directed to a system that generates an optimal item placement for one or more items. The system receives one or more items, where each item includes an item height and an item width. The system further receives a container, where the container comprises a container height and a container width. The system further generates a number of copies for each item and a position within the container for each copy of each item, where each copy of each item is placed at the corresponding position within the container, where the copies of the one or more items are placed within the container in a random order, and where at least one copy of the one or more items is placed at a randomly chosen position. The system further outputs the number of copies for each item and the position within the container for each copy of each item.

### BRIEF DESCRIPTION OF THE DRAWINGS

Further embodiments, details, advantages, and modifications will become apparent from the following detailed description of the preferred embodiments, which is to be taken in conjunction with the accompanying drawings.

FIG. 1 illustrates a block diagram of a system that can implement an embodiment of the invention.

FIG. 2 illustrates an example container and an example placement of items within the container, according to an embodiment of the invention.

FIG. 3 illustrates a flow diagram of the functionality of an item placement optimizer module, according to an embodiment of the invention.

FIG. 4 illustrates a flow diagram of an item placement algorithm that is implemented by an item placement optimizer module, according to an embodiment of the invention.

FIG. 5 illustrates a flow diagram of a smallest revenue loss function of an item placement algorithm that is implemented by an item placement optimizer module, according to an embodiment of the invention.

FIG. 6 illustrates a flow diagram of a center placement function of an item placement algorithm that is implemented by an item placement optimizer module, according to an embodiment of the invention.

FIG. 7 illustrates a flow diagram of a highest revenue item placement determination function of an item placement algorithm that is implemented by an item placement optimizer module, according to an embodiment of the invention.

FIG. 8 illustrates a flow diagram of a placement point iteration function of an item placement algorithm that is implemented by an item placement optimizer module, according to an embodiment of the invention.

### DETAILED DESCRIPTION

In one embodiment, a system optimizes a placement of one or more items within a container, so as to maximize a total revenue of all placed items. Each item can be a two-dimensional rectangular item with an item height and an item width. Further, the container can be a two-dimensional rectangular container with a container height and a container width. Each item can be placed without overlap, and a bottom edge of each item can be parallel to a bottom of the container. Further, several copies of each item can be placed within the container, where all copies can be horizontally adjacent to each other, jointly creating a rectangle with a height equal to an item height of the item. The number of copies for an item that are placed within the container can be between a specified minimum allowed value and a specified maximum allowed value. The revenue obtained from placing an item with zero or more copies of the item can be an increasing function of the number of copies of the item. The system can utilize randomness in order to place the one or more items within the container (such as placing items in a random order, or placing an item at a randomly chosen location from along a list of desired locations). The system can further repeat a procedure for determining a placement of the one or more items multiple times, and can select an optimal item placement that achieves the largest revenue.

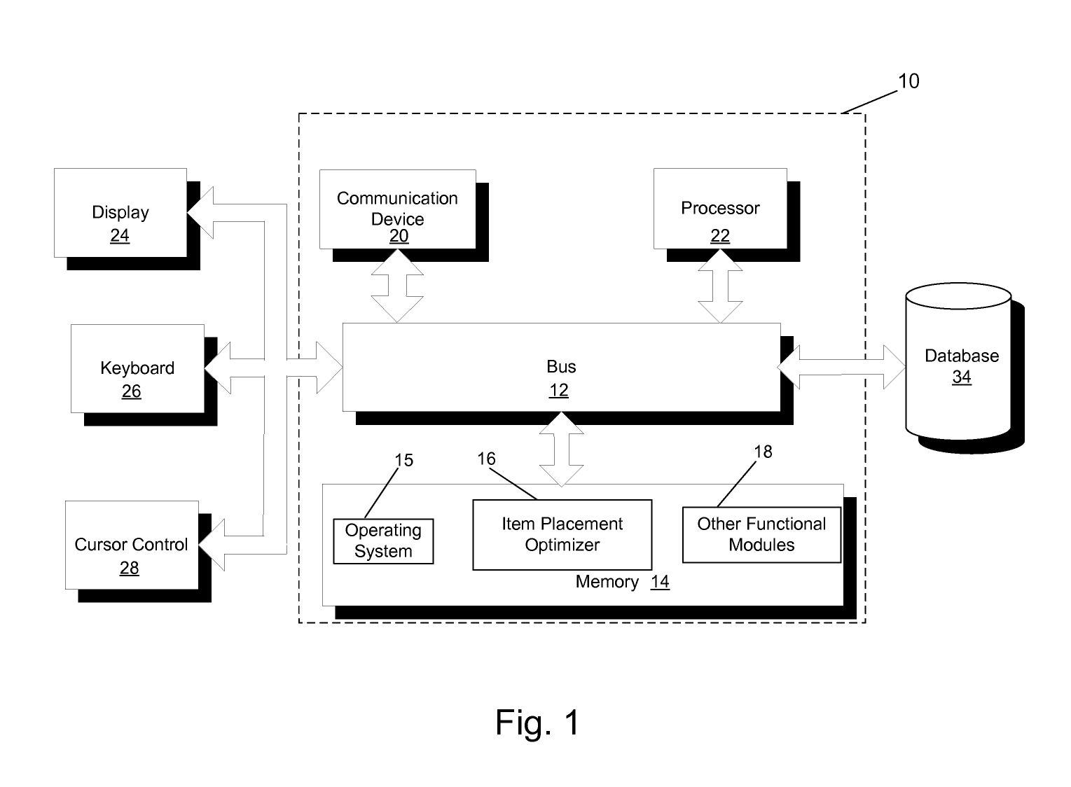

FIG. 1 illustrates a block diagram of a system 10 that can implement one embodiment of the invention. System 10 includes a bus 12 or other communications mechanism for communicating information between components of system 10. System 10 also includes a processor 22, operatively coupled to bus 12, for processing information and executing instructions or operations. Processor 22 may be any type of general or specific purpose processor. System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of machine or computer-readable medium. System 10 further includes a communication device 20, such as a network interface card or other communications interface, to provide access to a network. As a result, a user may interface with system 10 directly, or remotely through a network or any other method.

A computer-readable medium may be any available medium that can be accessed by processor 22. A computer-readable medium may include both a volatile and nonvolatile medium, a removable and non-removable medium, a communication medium, and a storage medium. A communication medium may include computer readable instructions, data structures, program modules or other data in a modulated data signal such as a carrier wave or other transport mechanism, and may include any other form of information delivery medium known in the art. A storage medium may include RAM, flash memory, ROM, erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

Processor 22 can also be operatively coupled via bus 12 to a display 24, such as a Liquid Crystal Display (“LCD”). Display 24 can display information to the user. A keyboard 26 and a cursor control device 28, such as a computer mouse, can also be operatively coupled to bus 12 to enable the user to interface with system 10.

According to one embodiment, memory 14 can store software modules that may provide functionality when executed by processor 22. The modules can include an operating system 15, an item placement optimizer module 16, as well as other functional modules 18. Operating system 15 can provide an operating system functionality for system 10. Item placement optimizer module 16 can provide functionality for generating an optimal item placement for one or more items, as will be described in more detail below. In certain embodiments, item placement optimizer module 16 can comprise a plurality of modules, where each module provides specific individual functionality for generating an optimal item placement for one or more items. System 10 can also be part of a larger system. Thus, system 10 can include one or more additional functional modules 18 to include the additional functionality. For example, functional modules 18 may include modules that provide additional functionality, such as the “Space Optimization” product from Oracle Corporation.

Processor 22 can also be operatively coupled via bus 12 to a database 34. Database 34 can store data in an integrated collection of logically-related records or files. Database 34 can be an operational database, an analytical database, a data warehouse, a distributed database, an end-user database, an external database, a navigational database, an in-memory database, a document-oriented database, a real-time database, a relational database, an object-oriented database, or any other database known in the art.

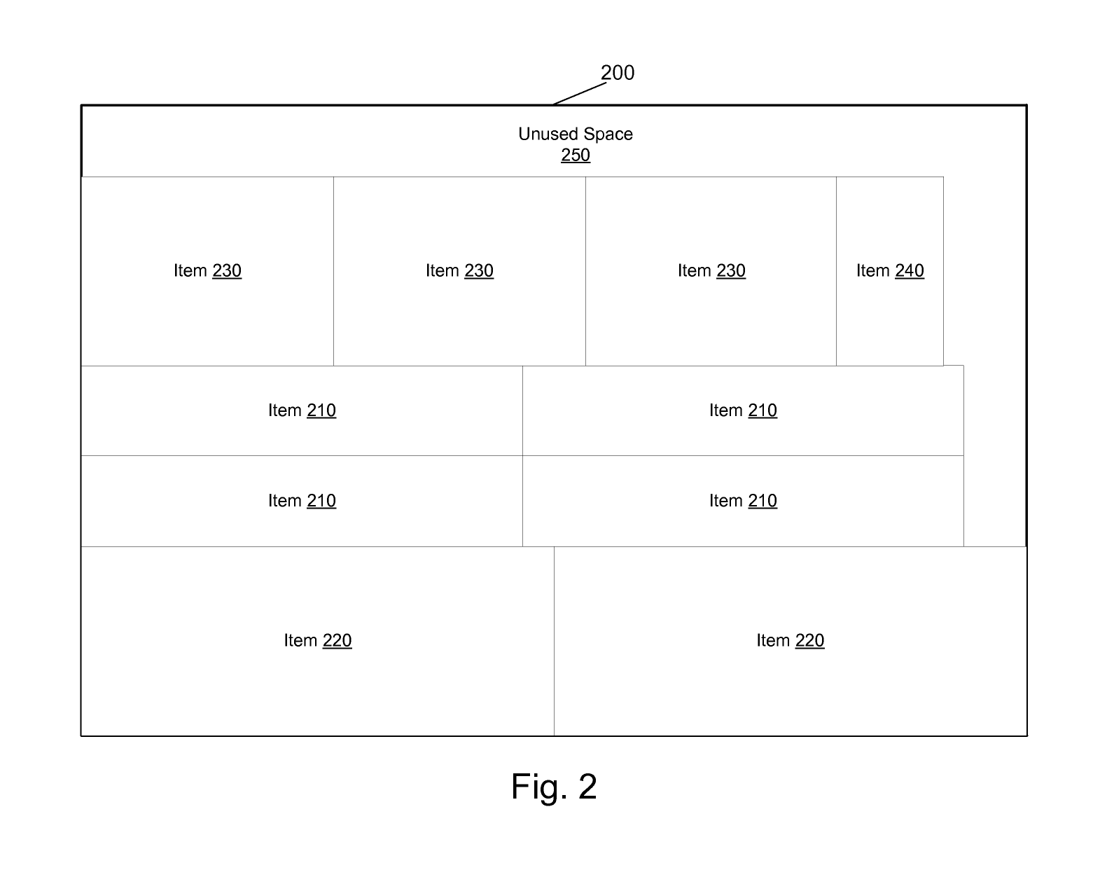

FIG. 2 illustrates an example container 200 and an example placement of items within container 200, according to an embodiment of the invention. As shown in the illustrated embodiment, container 200 is a two-dimensional rectangular container with a container height and a container width. One of ordinary skill in the art would readily appreciate that this is an example embodiment and that, in other alternate embodiments, container 200 can be an alternate shape. Examples of container 200 include a freezer chest, a peg board, a floor space, a supermarket shelf, a circuit board, a shipping container, etc.

Further, one or more items can be placed within container 200. More specifically, one or more copies of the one or more items can be placed within container 200. In certain embodiments, the one or more copies of the one or more items can be placed within container 200 so that a total area of the copies of the one or more items is less than or equal to an area of container 200. Further, in certain embodiments, the copies of the one or more items can be placed within container 200 so that the copies of the one or more items do not overlap one another. Additionally, in certain embodiments, a bottom edge of each copy of each item can be parallel to a bottom edge of container 200. Further, in some of the embodiments, all copies of each item placed within container 200 can be horizontally adjacent to each other, jointly creating a rectangle whose height is equal to an item height of the corresponding item. Additionally, in some embodiments, a number of copies for each item can be set to a value between a specified minimum value for the corresponding item and a specified maximum value for the corresponding item. Examples of items 210 include a freezer item, a peg, a server, supermarket product, a circuit, a shipping item, etc.

In the illustrated embodiment, the items that are placed within container 200 include items 210, 220, 230, and 240. Items 210, 220, 230, and 240 are each a two-dimensional rectangular item with an item height and an item width. One of ordinary skill in the art would readily appreciate that this is an example embodiment and that, in other alternate embodiments, an item (such as items 210, 220, 230, and 240) can be an alternate shape. Further, in the illustrated embodiment, a different number of copies of each item are placed within container 200. More specifically, four copies of item 210 are placed within container 200, two copies of item 220 are placed within container 200, three copies of item 230 are placed within container 200, and one copy of item 240 are placed within container 200. One of ordinary skill in the art would readily appreciate that this is an example embodiment and that, in other alternate embodiments, any number of copies of each item can be placed within container 200. In the illustrated embodiment, container 200 includes unused space 250. Unused space 250 represents any area of container 200 where an item is not placed. In certain embodiments, copies of items (such as items 210, 220, 230, and 240) can be placed within container 200 in order to minimize unused space 250.

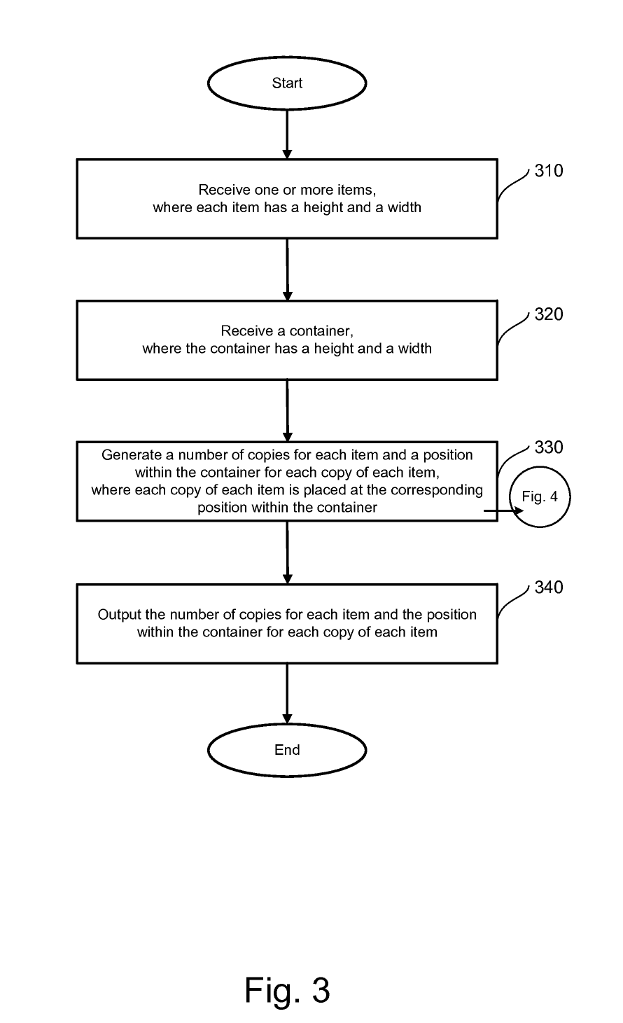

In certain embodiments, a revenue can be associated with each item that is placed within container 200 (such as items 210, 220, 230, and 240). The revenue can represent a revenue generated for an owner of the item through the placement of a copy of the item within container 200 (where the revenue can be generated through an eventual sale of the copy of the item, for example). Thus, a total revenue generated for an owner through the placement of one or more copies of an item within container 200 can increase as a number of copies of the item placed within container 200 increases. In other words, a total revenue for an item can be an increasing function of a number of copies of the item placed within container 200. Thus, in certain embodiments, one or more copies of one or more items (such as items 210, 220, 230, and 240) can be placed within container 200 in a configuration that maximizes total revenue for the one or more items. Such an item placement can be considered an optimal item placement. Functionality for generating an optimal item placement is further described in greater detail in conjunction with FIGS. 3-8.

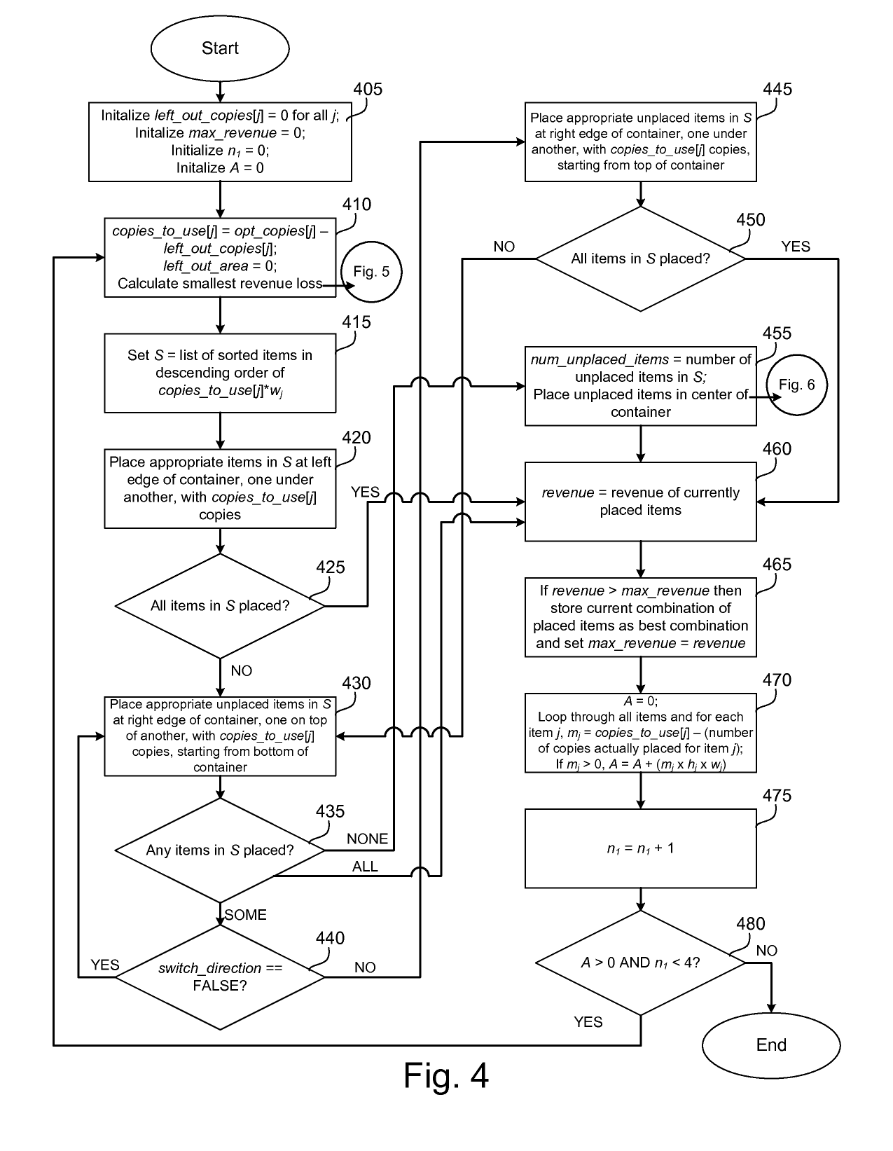

FIG. 3 illustrates a flow diagram of the functionality of an item placement optimizer module (such as item placement optimizer module 16 of FIG. 1), according to an embodiment of the invention. In one embodiment, the functionality of the flow diagram of FIG. 3, as well as the functionality of the flow diagrams of FIGS. 4, 5, 6, 7, and 8, are each implemented by software stored in a memory or some other computer-readable or tangible medium, and executed by a processor. In other embodiments, each functionality may be performed by hardware (e.g., through the use of an application specific integrated circuit (“ASIC”), a programmable gate array (“PGA”), a field programmable gate array (“FPGA”), etc.), or any combination of hardware and software.

The flow begins and proceeds to 310. At 310, one or more items are received, where each item has an item height and an item width. In other words, each item j has a height hⱼ, and a width wⱼ. In certain embodiments, each item is a two-dimensional item. In some of these embodiments, each two-dimensional item is a rectangular item. The flow proceeds to 320.

At 320, a container is received, where the container has a container height and a container width. In other words, the container has a height H and a width W. In certain embodiments, the container is a two-dimensional container. In some of these embodiments, the two-dimensional container is a rectangular container. The flow proceeds to 330.

At 330, a number of copies for each item and a position within the container for each copy of each item are generated, where each copy of each item is placed at the corresponding position within the container. In certain embodiments, the number of copies for each item and position within the container for each copy of each item are generated using an item placement algorithm, where the item placement algorithm is further described in greater detail below in conjunction with FIG. 4. In some of these embodiments, the copies of the one or more items are placed within the container in a random order. Further, in some of these embodiments, at least one copy of the one or more items is placed at a randomly chosen position.

In certain embodiments, a bottom edge of each copy of each item that is placed within the container is parallel to a bottom edge of the container. In some of these embodiments, all copies of each item placed within the container are horizontally adjacent to each other, jointly creating a rectangle whose height is equal to the item height of the corresponding item. Further, in certain embodiments, a total area of the copies of the one or more items placed within the container is less than or equal to an area of the container. In some of these embodiments, the copies of the one or more items placed within the container do not overlap one another.

In certain embodiments, the number of copies for each item is between a specified minimum value for the corresponding item and a specified maximum value for the corresponding item. In other words, a number of copies for an item j that are placed within the container is between a specified minimum value (i.e., a variable, “min_copies[j]”, for an item j) and a specified maximum value (i.e., a variable, “max_copies[j]”, for an item j).

In certain embodiments, a revenue is associated with each item. In these embodiments, a total revenue is an increasing function of a number of copies of each item. In other words, the revenue obtained from placing an item j with k copies is an increasing function of k. Thus, in some of these embodiments, the placement of the copies of the one or more items within the container maximizes the total revenue.

In certain embodiments, the number of copies for each item is an optimal number of copies for each item (i.e., a variable, “opt_copies[j]”, for each item j), under the constraints that: (a) the total area of all copies is less than or equal to the area of the container; (b) the number of copies for each item is between a specified minimum value for the corresponding item and a specified maximum value for the corresponding item (i.e., min_copies[j]<=opt_copies[j]<=max_copies[j] for each item j); and (c) a total width of all copies of each item is less than a width of the container (i.e., opt_copies[j]* wⱼ<=W). The optimal number of copies for each item can be computed by repeatedly selecting an item, where the placement of a copy of the item within the container maximizes an increase in total revenue, and placing the copy of the item within the container, where a total area of the copies of the one or more items placed within the container is less than or equal to an area of the container. In certain embodiments, the computing the optimal number of copies for each item can further include determining whether a placement of a copy of an item within the container maximizes an increase in total revenue by computing an increase in revenue associated with placing the copy of the item within the container, and dividing the increase in revenue by an area of the copy of the item. In certain embodiments, the selecting, the placing, and the determining are repeated multiple times and an optimal placement of the copy of the item is selected. Furthermore, in certain embodiments, at least one randomly chosen position for at least one copy of the one or more items can be modified after a copy of an item is placed within the container or removed from the container. Additionally, in certain embodiments, the number of copies for at least one item can depend on a previously placement of one or more copies of another item in a previous iteration. The flow proceeds to 340.

At 340, the number of copies for each item and the position within the container for each copy of each item are output. In certain embodiments, the output number of copies for each item and the output position within the container for each copy of each item are used to make a final placement of the one or more copies of the one or more items within the container. The flow then ends.

Further, in embodiments where each item is an item other than a two-dimensional rectangular item, the one or more items can be placed along the sides of a container. Potential placement points for new items can be identified (for example, by enclosing each non-rectangular item in a rectangular imaginary perimeter, and using the corners of the perimeter as potential replacement points). Finally, the one or more items can be placed at the potential placement points, and for each placed item, the potential placement points can be updated (where the new item is enclosed in a rectangular perimeter, and new potential placements points are defined, while the potential placement point where the item was placed is marked as occupied). If the items are three-dimensional, then the item can be enclosed into a three-dimensional imaginary rectangular box, where the corners of the rectangular box can be used as potential placement points for the one or more items.

Further, in an alternate embodiment, an algorithm that solves a one-dimensional “knapsack packing problem” can be used to calculate an optimal number of copies, where a “weight” of each copy of an item is an area of the copy of the item.

FIG. 4 illustrates a flow diagram of an item placement algorithm that is implemented by an item placement optimizer module (such as item placement optimizer module 16 of FIG. 1), according to an embodiment of the invention. The flow begins and proceeds to 405. At 405, an array of variables, “left_out_copies”, is initialized, where each variable, “left_out_copies[j]”, is initialized to 0 for all j items. Each left_out_copies[j] represents a number of copies for each item j that are not to be placed within a container. Further, a variable, “max_revenue”, is initialized to 0. Max_revenue represents a maximum revenue generated by an optimal combination of one or more copies of one or more items placed within a container. Additionally, a variable, “n₁”, is initialized to 0. N₁ represents an overall counter for the item placement algorithm, where the counter can limit a number of iterations of the item placement algorithm. Further, a variable, “A”, is initialized to 0. A represents a total area of one or more copies of one or more items that are desired to be placed within a container, but have not been placed within the container. The flow then proceeds to 410.

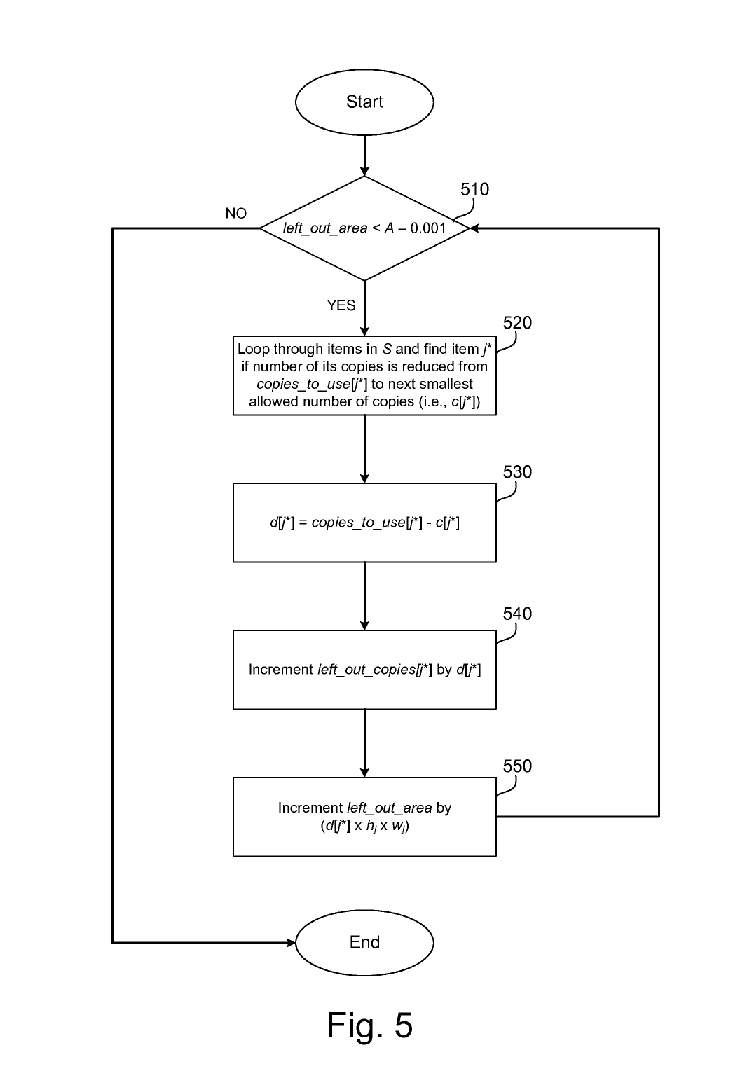

At 410, each variable, “copies_to_use[j]”, of an array of variables, “copies_to_use”, is set to (opt_copies[j]−left_out_copies[j]) for each item j. Each copies_to_use[j] represents a number of copies for each item j that can be used in item placement. Further, a variable, “left_out_area”, is initialized to 0. Left_out_area represents a total area of copies of items that is to be left out at a next top level iteration of the algorithm (starting at 410). Further, a smallest revenue loss function is implemented. A smallest revenue loss function: (a) calculates a revenue loss for each item j if a number of its copies is reduced from copies_to_use[j] to the next smallest allowed number of copies; (b) identifies an item j* with the smallest revenue loss of all j items; (c) updates left_out_copies[j*] based on the calculated smallest revenue loss; and (d) updates left_out_area based on the calculated smallest revenue loss. The smallest revenue loss function is further described below in greater detail in conjunction with FIG. 5. The flow then proceeds to 415.

At 415, the variable, S, is set to a list of one or more sorted items, where the one or more items are sorted in a descending order of copies_to_use[j]*wⱼ. In other words, the one or more items are sorted in a descending order of a total width of one or more copies of an item j that are to be placed, for all j items. The flow proceeds to 420.

At 420, starting from the beginning of list S, one or more copies of copies_to_use[j] copies are placed within at a left edge of a container, one under another, for all j items. If a copy of an item does not fit vertically into a remaining space within the container, the item is skipped, and the next item in S is considered until all items in S is considered. The flow then proceeds to 425.

At 425, it is determined whether all items in S have been placed within the container. If all items in S have been placed within the container, the flow proceeds to 460. If all items in S have not been placed within the container, then a variable, “switch_direction”, is set to “TRUE”, and the flow proceeds to 430. Switch_direction is a flag variable that represents whether copies of items are placed within the container in a downward direction or an upward direction.

At 430, if enough space is available, starting from the beginning of list S, one or more copies of copies_to_use[j] copies are placed at a right edge of the container, one on top of another, for all currently unplaced items, starting from a bottom of the container, shifting each copy of each item to the right as much as possible. If a copy of an item does not fit vertically into a remaining space within the container, the item is skipped, and the next item in S is considered until all items in S is considered. The flow then proceeds to 435.

At 435, it is determined whether any items in S have been placed within the container. If all items in S have been placed within the container (illustrated in FIG. 4 as “ALL”), the flow proceeds to 460. If no items in S have been placed within the container at 430 (illustrated in FIG. 4 as “NONE”), the flow proceeds to 455. If some items (but not all items) in S have been placed within the container at 430 (illustrated in FIG. 4 as “SOME”), the flow proceeds to 440.

At 440, it is determined whether switch_direction is equal to “FALSE.” If switch_direction is equal to “FALSE,” the flow returns to 430. If switch_direction is not equal to “FALSE,” the flow proceeds to 445.

At 445, if enough space is available, starting from the beginning of list S, one or more copies of copies_to_use[ⱼ] copies are placed at a right edge of the container, one under another, for all currently unplaced items, starting from a top of the container, shifting each copy of each item to the right as much as possible. If a copy of an item does not fit vertically into a space remaining, the item is skipped, and the next item in S is considered until all items in S is considered. The flow then proceeds to 450.

At 450, it is determined whether all items in S have been placed within the container. If all items in S have been placed within the container, the flow proceeds to 460. If some but not all items in S have been placed within the container at 445, the flow returns to 430. If no items in S have been placed within the container at 445, then switch_direction is set to “FALSE”, and the flow returns to 430.

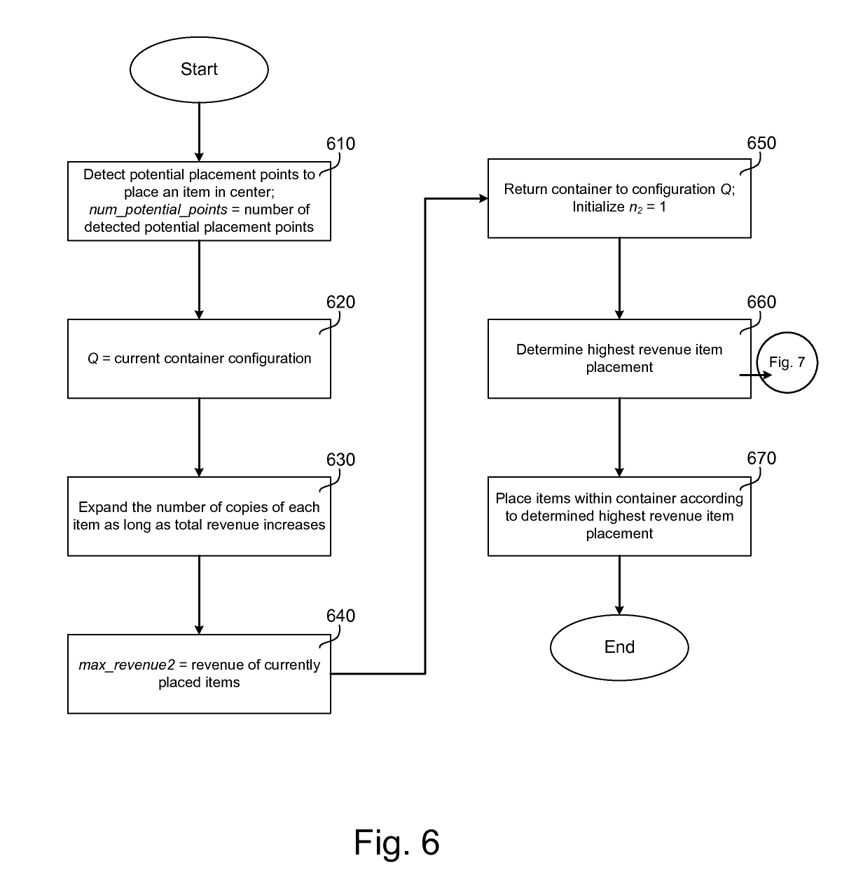

At 455, a variable, “num_unplaced_items”, is set to a number of unplaced items in S. Further, a center placement function is implemented. A center placement function places one or more copies of one or more items within a center of the container. The center placement function is further described below in greater detail in conjunction with FIG. 6. The flow then proceeds to 460.

At 460, a variable, “revenue”, is set to a revenue of the one or more currently placed copies of one or more items. Thus, revenue represents a total revenue of the current item placement of the one or more copies of the one or more items. The flow then proceeds to 465.

At 465, it is determined whether revenue is greater than max_revenue. If revenue is greater than max_revenue, the current item placement of the one or more copies of the one or more items is stored as a “best” item placement, and max_revenue is set to revenue. This is because the current item placement of the one or more copies of the one or more items generates more revenue (i.e., is “better”) than a previously stored “best” item placement of one or more copies of one or more items. The flow then proceeds to 470.

At 470, A is set to 0. All j items are looped through, and, for each item j, the variable, “mⱼ”, is set to (copies_to_use[j]−(a number of copies placed for item j in a current item placement). Thus, mⱼ represents a remaining number of copies for each item j that can be used in item placement. Further, it is determined whether mⱼ is greater than 0. If mⱼ is greater than 0, then A is set to (A+(mⱼ*hⱼ*wⱼ)). Thus, A represents a total area of the remaining number of copies for all j items. The flow then proceeds to 475.

At 475, n₁ is incremented by 1. The flow proceeds to 480.

At 480, it is determined whether A is greater than 0 and n₁ is less than 4. If A is greater than 0 and n₁ is less than 4, then the flow returns to 410. If A is not greater than 0, or if n₁ is not less than 4, then the flow ends.

In certain embodiments, the item placement algorithm described in conjunction with FIG. 4 can be utilized where there are many (e.g., fifty or greater) items that can be placed in the container. However, in embodiments where all available items are large (e.g. a total area of the fifty smallest items is greater than an area of the container), an randomized item placement algorithm can be utilized. In the randomized item placement algorithm, one or more items can be first placed at a left edge of the container, in a random order, with copies_to_use[j] copies, starting from a top of the container. If a copy of an item does not fit vertically into a remaining space, the item can be skipped from further consideration, and a subsequent item randomly selected from the remaining one or more items can be tried. If all items have been placed, the randomized item placement algorithm can proceed to 460, and can further proceed as previously described. Otherwise, the randomized item placement algorithm can proceed to place the remaining items at a right edge of the container, in a random order, with copies_to_use[j] copies. If a copy of an item does not fit vertically into a remaining space, the item can be skipped from further consideration, and a subsequent item randomly selected from the remaining one or more items can be tried. If all items have been placed, the randomized item placement algorithm can proceed to 460, and can further proceed as previously described. Otherwise, the randomized item placement algorithm can proceed to place the remaining items within a middle of the container.

FIG. 5 illustrates a flow diagram of a smallest revenue loss function of an item placement algorithm that is implemented by an item placement optimizer module (such as an item placement optimizer module 16 of FIG. 1), according to an embodiment of the invention. The flow begins and proceeds to 510. At 510, it is determined whether left_out_area is less than (A−0.001). If left_out_area is less than (A−0.001), the flow proceeds to 520. If left_out_area is not less than (A−0.001), the flow ends.

At 520, one or more items in S are looped through (where S represents a list of one or more items stored in a descending order of copies_to_use[j]*wⱼ), and an item j* is identified that represents an item with a smallest revenue loss if a number of its copies is reduced from copies_to_use[ⱼ] to the next smallest allowed number of copies (which might be 0), where the next smallest allowed number of copies for item j* is identified as “c[j*]”. The flow then proceeds to 530.

At 530, a variable, “d[j*]”, is set to (copies_to_use[j*]−c[j*]). d[j*] represents a number of copies of item j* that can be removed from placement within a container, because the removal of the number of copies of item j* generates the smallest revenue loss. The flow proceeds to 540.

At 540, left_out_copies[j*] is incremented by d[j*]. Thus, the copies of item j*, represented by d[j*], are not placed within the container, and left_out_copies[j*] is updated to reflect this. The flow proceeds to 550.

At 550, left_out_area is incremented by (d[j*]*hⱼ*wⱼ). Thus, no copies of item j* (or any item) are placed within the total area of the copies of item j*, represented by (d[j*]*hⱼ*wⱼ), and left_out_area is updated to reflect this. The flow then ends.

FIG. 6 illustrates a flow diagram of a center placement function of an item placement algorithm that is implemented by an item placement optimizer module (such as item placement optimizer module 16 of FIG. 1), according to an embodiment of the invention. The flow begins and proceeds to 610. At 610, one or more potential placement points to place a copy of an item in a center of a container are detected. For each copy of an item at a left edge of the container, the copy's upper and lower right corners are potential placement points. Further, for each copy of an item at a right edge of the container, the copy's upper and lower left corners are potential placements points. Additionally, a variable, “num_potential_points”, is set to a number of detected potential placement points. Thus, num_potential_points represents the number of potential placement points that are detected. The flow then proceeds to 620.

At 620, the variable, “Q”, is set to a current configuration of the container. Thus, Q represents the current configuration of the container. The flow then proceeds to 630.

At 630, a number of copies for each item is expanded (where copies of other items are removed if necessary), as long as a total revenue increases. In other words, as long as a total revenue increases, a number of copies of an item at a left edge of the container is expanded to the right, and a number of copies of all other items are expanded to the left. The flow then proceeds to 640.

At 640, a variable, “max_revenue2”, is set to a revenue of the one or more currently placed copies of one or more items. Thus, max_revenue2 represents a total revenue of the current item placement of the one or more copies of the one or more items. The flow then proceeds to 650.

At 650, the container is returned to configuration Q. Further, the variable, “n₂”, is initialized to 1. The flow then proceeds to 660.

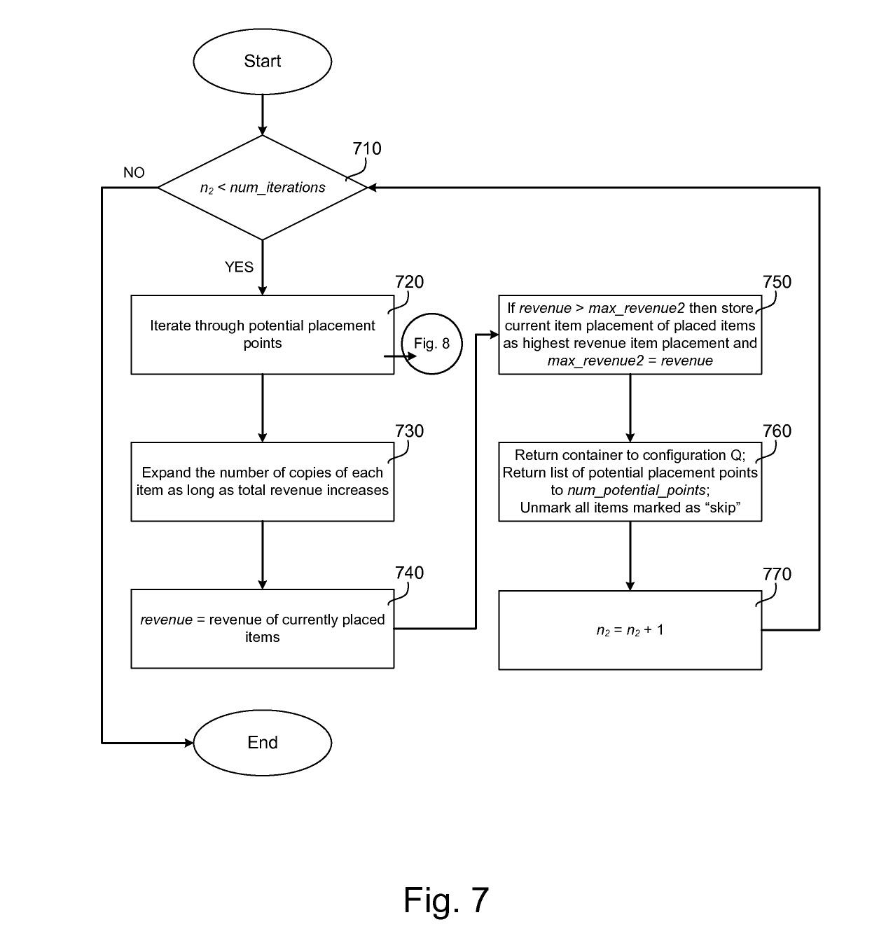

At 660, a highest revenue item placement determination function is implemented. A highest revenue item placement determination function determines an item placement of the one or more copies of the one or more items that generates a highest total revenue. The highest revenue item placement determination function is further described below in greater detail in conjunction with FIG. 7. The flow then proceeds to 660.

At 670, one or more copies of the one or more items are placed within the container according to the highest revenue item placement determined at 660. The flow then ends.

FIG. 7 illustrates a flow diagram of a highest revenue item placement determination function of an item placement algorithm that is implemented by an item placement optimizer module (such as item placement optimizer module 16 of FIG. 1), according to an embodiment of the invention. The flow begins and proceeds to 710. At 710, it is determined whether n₂ is less than num_iterations. If n₂ is less than num_iterations, the flow proceeds to 720. If n₂ is not less than num_iterations, the flow ends.

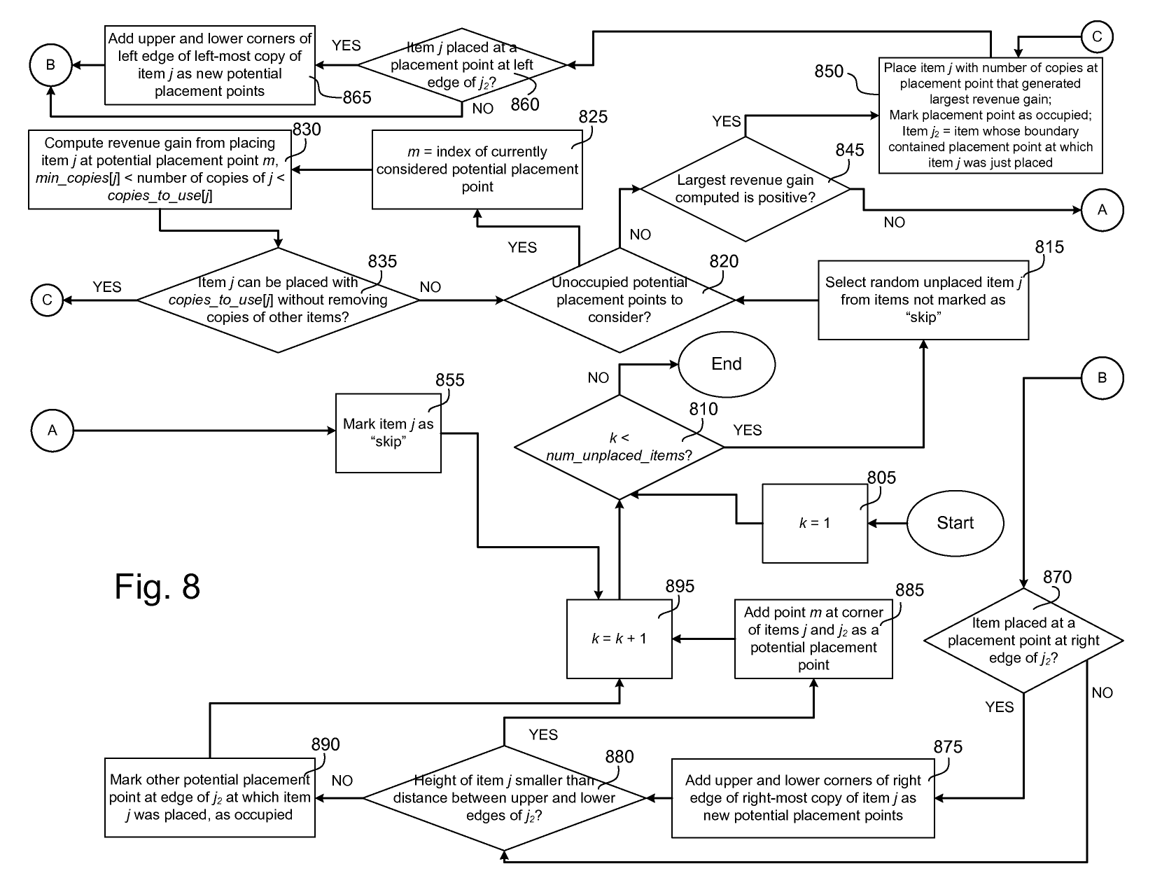

At 720, a placement point iteration function is implemented. A placement point iteration function iterates through one or more potential placement points within a container. The placement point interaction function is further described below in greater detail in conjunction with FIG. 8. The flow then proceeds to 730.

At 730, a number of copies for each item is expanded (where copies of other items are removed if necessary), as long as a total revenue increases. The flow then proceeds to 740.

At 740, revenue is set to a revenue of the one or more currently placed copies of one or more items. The flow then proceeds to 750.

At 750, it is determined whether revenue is greater than max_revenue2. If revenue is greater than max_revenue2, then the current item placement of the one or more copies of the one or more items is stored as the highest revenue item placement, and max_revenue2 is set to revenue. The flow then proceeds to 760.

At 760, the container is returned to configuration Q. Further, a list of one or more potential placement points is returned to the one or more potential placement points represented by num_potential_points. Additionally, all items that are marked as “skip” are unmarked. The flow then proceeds to 770.

At 770, n₂ is incremented by 1. The flow then returns to 710.

FIG. 8 illustrates a flow diagram of a placement point iteration function of an item placement algorithm that is implemented by an item placement optimizer module (such as item placement optimizer module 16 of FIG. 1), according to an embodiment of the invention. The flow begins, and proceeds to 805. At 805, a variable, “K”, is initialized to 1. The flow then proceeds to 810.

At 810, it is determined whether k is less than num_unplaced_items. If k is less than num_unplaced_items, then the flow proceeds to 815. If k is not less than num_unplaced_items, then the flow ends.

At 815, a random unplaced item j is selected from one or more unplaced items that have not been marked as “skip.” In certain embodiments, a probability of each unplaced item being placed within a container can be based on a value associated with each unplaced item, and an unplaced item with a higher value (i.e., larger probability) can be selected. The flow proceeds to 820.

At 820, it is determined whether there are any unoccupied potential placement points within the container to consider. If there are any unoccupied potential placement points within the container to consider, the flow proceeds to 825. If there are not any unoccupied potential placement points within the container to consider, the flow proceeds to 845.

At 825, a variable, “m”, is set to an index of a currently considered potential placement point. Thus, m represents the potential placement point that is currently being considered. The flow then proceeds to 830.

At 830, a revenue gain that is generated from placing a copy of item j at potential placement point m within the container, with a total number of copies of item j ranging from min_copies[j] to copies_to_use[j], is computed, where copies of other items are removed if necessary. The flow then proceeds to 835.

At 835, it is determined whether copies_to_use[j] copies of item j can be placed within the container without having to remove copies of any other items. If copies_to_use[j] copies of item j can be placed within the container without having to remove copies of any other items, the flow proceeds to 850. If copies_to_use[j] copies of item j cannot be placed within the container without having to remove copies of any other items, the flow returns to 820.

At 845, it is determined whether the largest revenue gain computed at 830 is positive. If the largest revenue gain computed at 830 is positive, then the flow proceeds to 850. If the largest revenue gain computed at 830 is not positive, then the flow proceeds to 855 (illustrated in FIG. 8 as path “A”).

At 850, one or more copies of an item j that generated a largest revenue gain (or an item j that can be placed within the container without having to remove copies of any other items as determined at 835) are placed within the container, where a copy of item j is placed at the placement point that generated the largest revenue gain (or at the placement point identified at 835). The placement point is marked as “occupied.” A variable, “j₂”, is set to an item whose boundary contained the placement point at which a copy of the item j was just previously placed. Thus, j₂ represents an item that is an adjoining item to item j. The flow then proceeds to 860.

At 855, item j is marked as “skip”. The flow then proceeds to 895.

At 860, it is determined whether item j was placed at a placement point at a left edge of item j₂. If item j was placed at a placement point at a left edge of item j₂, then the flow proceeds to 865. If item j was not placed at a placement point at a left edge of item j₂, then the flow proceeds to 870 (illustrated in FIG. 8 as path “B”).

At 865, upper and lower corners of a left edge of a left-most copy of item j are added as new potential placement points. The flow then proceeds to 870 (illustrated in FIG. 8 as path “B”).

At 870, it is determined whether item j was placed at a placement point at a right edge of item j₂. If item j was placed at a placement point at a right edge of item j₂, then the flow proceeds to 875. If item j was not placed at a placement point at a right edge of item j₂, then the flow proceeds to 880.

At 875, upper and lower corners of a right edge of a right-most copy of item j are added as new potential placement points. The flow then proceeds to 880.

At 880, it is determined whether a height of item j is smaller than a distance between the upper and lower edges of item j₂. If the height of item j is smaller than a distance between the upper and lower edges of item j₂, then the flow proceeds to 885. If the height of item j is not smaller than a distance between the upper and lower edges of item j₂, then the flow proceeds to 890.

At 885, point m at corner of items j and j₂ is added a potential placement point. The flow then proceeds to 895.

At 890, the other potential placement point at the edge of item j₂, at which item j was just previously placed, is marked as “occupied”. The flow then proceeds to 895.

At 895, k is incremented by 1. The flow then returns to 810.

In certain embodiments, the potential placement points can be managed using alternate methods. For example, in certain alternate embodiments, if, while placing an item j, one or more copies of another item j₃ need to be removed, then one or more potential placement points at a boundary of the one or more copies of item j₃. Furthermore, a potential placement point at which item j₃ was placed can be marked as unoccupied. Thus, in certain embodiments, a set of one or more potential placement points can be appropriately modified after a copy of an item is placed.

Thus, according to an embodiment, a system can be provided that optimizes a placement of one or more items within a container, where each item can be a two-dimensional rectangular item, and the container can be a two-dimensional rectangular container. The algorithm used by the system can significantly reduce the time required to determine an optimal item placement. Further, the algorithm used by the system can increase revenue maximization of an item placement as a size of a two-dimensional rectangular packing problem (i.e., an area of a container and a number of items to be placed in the container) is increased.

The features, structures, or characteristics of the invention described throughout this specification may be combined in any suitable manner in one or more embodiments. For example, the usage of “one embodiment,” “some embodiments,” “certain embodiment,” “certain embodiments,” or other similar language, throughout this specification refers to the fact that a particular feature, structure, or characteristic described in connection with the embodiment may be included in at least one embodiment of the present invention. Thus, appearances of the phrases “one embodiment,” “some embodiments,” “a certain embodiment,” “certain embodiments,” or other similar language, throughout this specification do not necessarily all refer to the same group of embodiments, and the described features, structures, or characteristics may be combined in any suitable manner in one or more embodiments.

One having ordinary skill in the art will readily understand that the invention as discussed above may be practiced with steps in a different order, and/or with elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

We claim:

1. A computer-readable medium having instructions stored thereon that, when executed by a processor, cause the processor to generate an optimal item placement for one or more items, the generating comprising:
receiving one or more items, wherein each item comprises an item height and an item width;
receiving a container, wherein the container comprises a container height and a container width;
generating a number of copies for each item and a position within the container for each copy of each item, wherein each copy of each item is placed at the corresponding position within the container, wherein the copies of the one or more items are placed within the container in a random order, and wherein at least one copy of the one or more items is placed at a randomly chosen position; and
outputting the number of copies for each item and the position within the container for each copy of each item.

2. The computer-readable medium of claim 1,
wherein a bottom edge of each copy of each item is parallel to a bottom edge of the container; and
wherein all copies of each item placed within the container are horizontally adjacent to each other, jointly creating a rectangle comprising a height equal to the item height of the corresponding item.

3. The computer-readable medium of claim 1,
wherein the number of copies for each item is between a specified minimum value for the corresponding item and a specified maximum value for the corresponding item.

4. The computer-readable medium of claim 1,
wherein a total area of the copies of the one or more items placed within the container is less than or equal to an area of the container.

5. The computer-readable medium of claim 4, wherein the copies of the one or more items placed within the container do not overlap one another.

6. The computer-readable medium of claim 1,
wherein a revenue is associated with each item;
wherein a total revenue is an increasing function of the number of copies of each item; and
wherein the placement of the copies of the one or more items within the container maximizes the total revenue.

7. The computer-readable medium of claim 6, the generating further comprising:
selecting an item, wherein a placement of a copy of the item within the container maximizes an increase in total revenue; and
placing the copy of the item within the container where a total area of the copies of the one or more items placed within the container is less than or equal to an area of the container.

8. The computer-readable medium of claim 7, the generating further comprising:
determining whether the placement of the copy of the item within the container maximizes the increase in total revenue by computing an increase in revenue associated with placing the copy of the item within the container, and dividing the increase in revenue by an area of the copy of the item.

9. The computer-readable medium of claim 8, wherein the selecting, the placing, and the determining are repeated multiple times and an optimal placement of the copy of the item is selected.

10. The computer-readable medium of claim 1,
wherein each item comprises a two-dimensional item; and
wherein the container comprises a two-dimensional container.

11. The computer-readable medium of claim 9,
wherein each two-dimensional item comprises a rectangular item; and
wherein the two-dimensional container comprises a rectangular container.

12. The computer-readable medium of claim 1, the generating further comprising modifying at least one randomly chosen position for at least one copy of the one or more items after a copy of an item is placed within the container or removed from the container.

13. The computer-readable medium of claim 1, wherein the number of copies for at least one item depends on a placement of one or more copies of another item in a previous iteration.

14. A computer-implemented method for generating an optimal item placement for one or more items, the computer-implemented method comprising:
receiving one or more items, wherein each item comprises an item height and an item width;
receiving a container, wherein the container comprises a container height and a container width;
generating a number of copies for each item and a position within the container for each copy of each item, wherein each copy of each item is placed at the corresponding position within the container, wherein the copies of the one or more items are placed within the container in a random order, and wherein at least one copy of the one or more items is placed at a randomly chosen position; and
outputting the number of copies for each item and the position within the container for each copy of each item.

15. The computer-implemented method of claim 14,
wherein a bottom edge of each copy of each item is parallel to a bottom edge of the container; and
wherein all copies of each item placed within the container are horizontally adjacent to each other, jointly creating a rectangle comprising a height equal to the item height of the corresponding item.

16. The computer-implemented method of claim 14,
wherein the number of copies for each item is between a specified minimum value for the corresponding item and a specified maximum value for the corresponding item.

17. The computer-implemented method of claim 14,
wherein a revenue is associated with each item;
wherein a total revenue is an increasing function of the number of copies of each item; and
wherein the placement of the copies of the one or more items within the container maximizes the total revenue.

18. The computer-implemented method of claim 17, further comprising:
selecting an item, wherein a placement of a copy of the item within the container maximizes an increase in total revenue; and
placing the copy of the item within the container where a total area of the copies of the one or more items placed within the container is less than or equal to an area of the container.

19. A system for generating an optimal item placement for one or more items, comprising:
an item receiving module configured to receive one or more items, wherein each item comprises an item height and an item width;
a container receiving module configured to receive a container, wherein the container comprises an item height and an item width;
an item placement generation module configured to generate a number of copies for each item and a position within the container for each copy of each item, wherein each copy of each item is placed at the corresponding position within the container, wherein the copies of the one or more items are placed within the container in a random order, and wherein at least one copy of the one or more items is placed at a randomly chosen position; and
an item placement output module configured to output the number of copies for each item and the position within the container for each copy of each item.

20. The system of claim 19,
wherein a bottom edge of each copy of each item is parallel to a bottom edge of the container; and
wherein all copies of each item placed within the container are horizontally adjacent to each other, jointly creating a rectangle comprising a height equal to the item height of the corresponding item.

21. The system of claim 19,
wherein the number of copies for each item is between a specified minimum value for the corresponding item and a specified maximum value for the corresponding item.

22. The system of claim 19,
wherein a revenue is associated with each item;
wherein a total revenue is an increasing function of the number of copies of each item; and
wherein the placement of the copies of the one or more items within the container maximizes the total revenue.

23. The system of claim 20, further comprising:
an item selection module configured to select an item, wherein a placement of a copy of the item within the container maximizes an increase in total revenue; and
an item copy placement module configured to place the copy of the item within the container where a total area of the copies of the one or more items placed within the container is less than or equal to an area of the container.
